(19) United States
(12) Patent Application Publication
(10) Pub. No.: US 2011/0064954 A1
(43) Pub. Date: Mar. 17, 2011

(54) METHOD FOR CONDITIONING INSULATING RESIN AND ITS USE

(75) Inventor: Satoru Shimizu, Kanagawa (JP)

(73) Assignee: EBARA-UDYLITE CO., LTD., Tokyo (JP)

(21) Appl. No.: 12/993,744

(22) PCT Filed: May 22, 2008
(86) PCT No.: PCT/JP08/59445

§ 371 Date: Nov. 19, 2010

(51) Int. Cl. B32B 15/092; C08G 18/82; B05D 3/10; C08F 26/00

(52) U.S. Cl. 428/418; 525/452; 427/304; 526/310

(57) ABSTRACT

For the purpose of providing a method capable of conveniently enhancing adhesion between a metal film and an insulating resin upon forming the metal film on a flat surface of the insulating resin, the invention provides a method for conditioning an insulating resin, comprising hydrophilizing an insulating resin, treating the insulating resin with a solution containing a polymer having a primary amine, a secondary amine or both of them on a side chain thereof, and a method for metallizing an insulating resin utilizing the conditioning method.

### TECHNICAL FIELD

The present invention relates to a method for conditioning an insulating resin, and more specifically, relates to a method for conditioning an insulating resin, capable of being utilized as a pre-treatment for forming a metal film with good adhesion on a flat surface of the insulating resin, and to a method for metallizing an insulating resin utilizing the conditioning method.

### BACKGROUND ART

In the case where a metal film is deposited on a surface of an insulating resin for metallization, it has been known that the surface of the insulating resin is roughened with a chemical reagent, such as an alkaline permanganic acid solution, for enhancing adhesion between the deposited metal and the insulating resin (Patent Document 1). The surface of the insulating resin is roughened with the chemical reagent to a roughness of approximately 5 μm, and the adhesion between the metal film and the insulating resin is enhanced in the subsequent metallization treatment. However, the roughness on the surface of the insulating resin is demanded to be 1 μm or less according to miniaturization of electronic circuits in recent years, and the aforementioned method fails to deal with the demand.

In recent years, insulating resin itself is being substituted with a resin having a low dielectric constant, such as polyimide and cyanate type resins (Patent Document 2). Even when the insulating resin with a surface roughness (Rz) of 1 μm or less is applied with a cationic surfactant, such as an alkyltrimethylammonium salt, which has been used as a conditioning agent, for through-hole plating of a conventional printed circuit, only low adhesion to the metal is obtained to provide practical problem.

As another technique for metallization of a smooth surface of an insulating resin with good adhesion, it has been known that a nitrogen-containing compound is attached to the surface of the insulating resin and then cured by heating to form a nitrogen-containing compound layer, and then the metallization is performed (Patent Document 3). However, the method is complicated due to many process steps contained, and thus is not convenient.

### Patent Document 1: Japanese Patent No. 2,877,110

### Patent Document 2: JP-A-2005-240019

### Patent Document 3: JP-A-2003-332738

### DISCLOSURE OF THE INVENTION

### Problems to be Solved by the Invention

Accordingly, an object of the invention is to provide a method capable of enhancing adhesion between a metal film and an insulating resin upon forming minute circuits on a smooth surface of the insulating resin in a convenient method.

### Means for Solving the Problems

As a result of earnest investigations made by the present inventor for solving the problems, it has been found that in the process of metallizing a flat surface of an insulating resin, adhesion between the insulating resin and a metal film can be enhanced, without roughening the surface of the insulating resin, by subjecting the surface of the insulating resin to a hydrophilization treatment and then a conditioning treatment with a specific polymer solution, and thus the present invention has been completed.

Accordingly, the present invention relates to a method for conditioning an insulating resin that contains, after subjecting an insulating resin to a hydrophilization treatment, treating the insulating resin with a solution containing a polymer having a primary amine, a secondary amine or both of them on a side chain thereof.

The invention also relates to a method for metallizing an insulating resin that contains: subjecting an insulating resin to a hydrophilization treatment; treating the insulating resin with a solution containing a polymer having a primary amine, a secondary amine or both of them on a side chain thereof; applying a catalyst to the insulating resin; and subjecting the insulating resin to a metallization treatment.

The invention further relates to a conditioning liquid that contains a polymer having a primary amine, a secondary amine or both of them on a side chain thereof.

The invention further relates to a metal-plated product obtained by the method for metallizing an insulating resin.

### ADVANTAGES OF THE INVENTION

According to the method for conditioning an insulating resin of the present invention, the adhesion between the insulating resin and the catalyst or the metal film can be enhanced owing to the bonding power of the polymer used for conditioning, without roughening the surface of the insulating resin. Furthermore, the method does not require any special process step, such as curing under heating and drying, in the course of from the conditioning step to the metallization step.

Accordingly, an excellent plated product with enhanced adhesion between an insulating resin and a metal film can be conveniently obtained by performing metallization of an insulating resin with the method for conditioning an insulating resin of the present invention.

### BEST MODE FOR CARRYING OUT THE INVENTION

The method for conditioning an insulating resin of the present invention (which may be hereinafter referred to as the method of the invention) is performed by, after subjecting an insulating resin to a hydrophilization treatment, treating the insulating resin with a solution containing a polymer having a primary amine, a secondary amine or both of them on a side chain thereof.

The insulating resin, to which the method of the invention is applied, is not particularly limited, and a resin that is ordinarily used as an insulating layer for producing an electronic circuit may be used. Examples of the insulating resin include a resin containing a cyanate compound and an epoxy compound, and a polyimide resin. Among the resins, a resin having a low dielectric constant, such as a resin having a dielectric constant of 4 or less (1 GHz), and a resin having a surface roughness (Rz) of 1 μm or less, are preferred. Examples of the resin include, as commercially available products, ABF-GZ9-2 (produced by Ajinomoto Fine-Techno Co., Inc., surface roughness (Rz): 0.35 μm, dielectric constant: 3.1 (1 GHz)) and a polyimide film, Kapton 100EN (produced by Du Pont-Toray Co., Ltd., surface roughness (Rz): 0.1 μm, dielectric constant: 3.7 (1 GHz)). In the present invention, the surface roughness (Rz) of the resin is the maximum height described in JIS B0601-2001 and can be measured with a surface shape measuring apparatus (VF-7500, produced by Keyence Corporation) or the like.

The hydrophilization treatment for the insulating resin is not particularly limited, and a method that does not roughen the surface of the insulating resin is preferred. Examples of the method include a physical treatment, such as an ultraviolet ray irradiation treatment under an atmospheric pressure, a plasma treatment and a corona discharge treatment, and a chemical treatment, such as treatments with an alkaline permanganic acid solution, an organic solvent, a high concentration alkali metal aqueous solution or the like. In the hydrophilization treatment, an ultraviolet ray irradiation treatment is preferred owing to easiness thereof. As a preferred example of the conditions for ultraviolet ray irradiation, an insulating resin may be irradiated with an ultraviolet ray having a wavelength of from 180 to 290 nm and an intensity of 5 mW/cm² or more in the air for approximately 5 minutes.

The insulating resin thus hydrophilized is then treated with a solution (which may be hereinafter referred simply to as a polymer solution) containing a polymer having a primary amine, a secondary amine or both of them on a side chain thereof (which may be hereinafter referred simply to as a nitrogen-containing polymer). Examples of the nitrogen-containing polymer contained in the polymer solution include a polymer of a monomer selected from a vinylamine, an allylamine, a diallylamine and a vinylamidine, and a copolymer of the monomers. Specific examples of the polymer of the monomers and the copolymer of the monomers include a polyvinylamine, a polyallylamine, a polydiallylamine and a polyvinylamidine represented by the following formulae (I) to (IV), respectively. The polyvinylamine, polyallylamine, polydiallylamine and polyvinylamidine may be polymers obtained by polymerization or copolymerization of the monomers using conventional methods or may be commercially available products, such as PAA-15C (produced by Nitto Boseki Co., Ltd.), PVAM-0570B (produced by Dia-Nitrix Co., Ltd.), PAS-21CL1 (produced by Nitto Boseki Co., Ltd.), PAA-D11-HCl (produced by Nitto Boseki Co., Ltd.) and PVAD-L (produced by Dia-Nitrix Co., Ltd.).

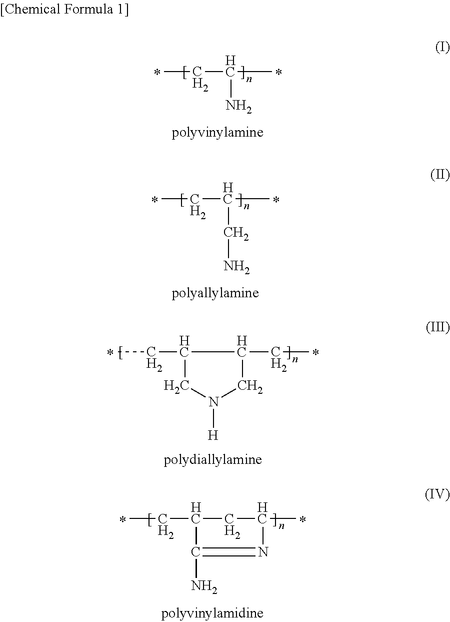

The polymer solution of the nitrogen-containing polymer may be prepared by dissolving the nitrogen-containing polymer in a solvent, such as water, a known degreasing liquid or the like. The content of the nitrogen-containing polymer in the polymer solution is not particularly limited and may be, for example, 0.01 g/L or more, and preferably from 0.1 to 1.0 g/L. The polymer solution may have pH of from 1 to 14, and preferably from 7 to 14.

The treatment of the insulating resin with the polymer solution may be performed by immersing the insulating resin in the polymer solution. The conditions therefor are not particularly limited, and for example, the insulating resin may be immersed in the polymer solution at a temperature of from 0 to 80° C., and preferably from 20 to 60° C., for 30 seconds or more, and preferably from 1 to 5 minutes.

The insulating resin thus conditioned in the aforementioned manner may be metallized in a known manner. Specifically, the insulating resin thus conditioned is applied with a catalyst in a known manner and then metallized in a known manner.

The catalyst for application to the insulating resin is not particularly limited, and any one of a mixed colloid catalyst of palladium and tin, a palladium-amine complex catalyst, such as 2-aminopyridine, and the like may be used. The catalyst may be a commercially available product, such as PC-65H and PB-318 (both produced by Ebara-Udylite Co., Ltd.). The conditions where the catalyst is applied to the insulating resin are not particularly limited and may be in accordance with known conditions. Examples of the conditions where the catalyst is applied to the insulating resin include such a condition that the insulating resin is immersed in a catalyst aqueous solution having a palladium concentration of 0.1 g/L at 30° C. for 5 minutes.

The insulating resin having the catalyst applied thereto in the aforementioned manner is then subjected to a metallization treatment. Examples of the metallization treatment include a plating treatment and a sputtering treatment. Examples of the plating treatment include electroplating, electroless plating and direct plating, and among these, electroless plating is preferred. Examples of the electroless plating used include electroless copper plating, electroless nickel plating and electroless cobalt plating, and electroless copper plating, which is easily etched, is preferred in consideration of formation of circuits.

Preferred examples of the electroless copper plating include copper plating having a thickness of approximately 0.5 μm that is formed in such a manner that the insulating resin having the catalyst applied thereto is immersed in an electroless copper plating solution containing a copper salt, formalin and a complexing agent at 30° C. for 15 minutes and then dried at approximately 120° C. in an oven.

The insulating resin thus metallized in the aforementioned manner (i.e., a metal-plated product) has high adhesion to the metal film. Specifically, the 90° peel strength according to JIS C5012 of the metal-plated product may be 0.5 kN/m or more, and preferably 0.7 kN/m or more.

The following factors are currently considered to contribute to forming a metal film having high adhesion to an insulating film in the conditioning method and the metallizing method utilizing the conditioning method of the present invention. The insulating resin containing a cyanate compound and an epoxy compound is regarded as having an oxazoline ring, which becomes an isocyanate group R—N═C—O or a carboxyl group R—NH—COOH through a hydrophilization treatment. It is assumed that a primary or secondary amine of the nitrogen-containing polymer is chemically bonded to these functional groups to form a urea bond having a structure R—NH—CO—NH—R′, which forms a chelate bond with the metal, thereby providing firm adhesion between the resin and the catalyst, such as palladium. In the case where the insulating resin is a polyimide resin, it is similarly assumed that immersion of the resin in the alkali solution forms polyamic acid, and a primary or secondary amine of the nitrogen-containing polymer is chemically bonded thereto to form a urethane bond having a structure R—CO—NH—R′, which forms a chelate bond with the catalyst metal. On the other hand, it is thought that a polymer having a tertiary amine or a quaternary ammonium salt does not form a urea bond or a urethane bond, and thus fails to provide adhesion between the insulating resin and the metal.

### EXAMPLE

The present invention is described in more detail with reference to the following Examples. However, the invention should not be whatsoever restricted at all by these Examples.

### Example 1

### Metallization of Insulating Resin

### (1) Hydrophilization Treatment

A cyanate type resin film (ABF-GZ9-2, produced by Ajinomoto Fine-Techno Co., Inc.) was laminated on a surface of a double sided copper clad plate FR-4 by vacuum press at 170° C. for 30 minutes. The surface roughness (Rz) of the resin film after lamination measured with a surface shape measuring apparatus (VF-7500, produced by Keyence Corporation) was 0.35 μm. The surface of the resin film was irradiated with an ultraviolet ray (wavelength: 254 nm, ultraviolet ray intensity: 20 mW/cm²) using an ultraviolet irradiation apparatus (produced by Senengineering Co., Ltd.) in the air for 5 minutes to perform a hydrophilization treatment. The surface roughness (Rz) of the resin after the hydrophilization treatment was 0.38 μm.

### (2) Conditioning Treatment

Following the hydrophilization treatment in the process (1) above, the resin was degreased with an alkaline degreasing liquid (PB-120, produced by Ebara-Udylite Co., Ltd.) at 50° C. for 5 minutes, and then immersed in a polymer aqueous solution containing a primary polyallylamine (PAA-15C, produced by Nitto Boseki Co., Ltd.) in a concentration of 1 g/L at 50° C. for 5 minutes to perform a conditioning treatment.

### (3) Application of Catalyst

Following the conditioning treatment in the process (2) above, the resin was immersed in a palladium catalyst solution (PC-65H, produced by Ebara-Udylite Co., Ltd.) at 50° C. for 5 minutes to perform application of the palladium catalyst, and then further subjected to an activation treatment with an activation solution (PC-66H, produced by Ebara-Udylite Co., Ltd.) at 30° C. for 3 minutes.

### (4) Electroless Plating

Following the application of catalyst in the process (3) above, the resin was immersed in an electroless copper plating solution (PB-506, produced by Ebara-Udylite Co., Ltd.) at 30° C. for 15 minutes to form a copper plated film having a thickness of 0.5 μm on the resin. The resin was then dried in an oven at 120° C. for 1 hour.

### (5) Electroplating

Following the electroless plating in the process (4) above, the resin was immersed in a copper electroplating solution (CU-BRITE21, produced by Ebara-Udylite Co., Ltd.) and treated at an electric current density of 3 A/dm² for 40 minutes to form a copper plated film having a thickness of 25 μm on the resin. The resin was then dried in an oven at 180° C. for 1 hour.

### Example 2

### Metallization of Insulating Resin

The insulating resin was metallized in the same manner as in Example 1 except that the polymer contained in the polymer aqueous solution in the process (2) of Example 1 was replaced by a primary polyvinylamine (PVAM-0570B, produced by Dia-Nitrix Co., Ltd.), a secondary polydiallylamine (PAS-21CL1, produced by Nitto Boseki Co., Ltd.), a copolymer of a primary polyallylamine and a secondary polydiallylamine (PAA-D11-HCl, produced by Nitto Boseki Co., Ltd.) or a primary polyvinylamidine (PVAD-L, produced by Dia-Nitrix Co., Ltd.).

### Comparative Example 1

### Metallization of Insulating Resin

The insulating resin was metallized in the same manner as in Example 1 except that the polymer aqueous solution in the process (2) of Example 1 was replaced by an aqueous solution containing a tertiary polydiallylamine (PAS-M1, produced by Nitto Boseki Co., Ltd.), a quaternary polydiallylamine (PAS-H-1L, produced by Nitto Boseki Co., Ltd.), a polyethyleneimine (Epomin SP-110, produced by Nippon Shokubai Co., Ltd.) or a quaternary ammonium salt cationic surfactant (Quartamin 24P, available from Kao Corporation), in a concentration of 1 g/L.

### Comparative Example 2

### Metallization of Insulating Resin

The insulating resin was metallized in the same manner as in Example 1 except that the conditioning treatment of the process (2) among the treatments of (1) to (5) in Example 1 was not performed.

### Test Example 1

### Measurement of 90° Peeling Test

90° peel strength of the plated products obtained in Example 1, Example 2, Comparative Example 1 and Comparative Example 2 were measured. The results obtained are shown in Table 1. The measurement was performed in accordance with JIS C5012 using the plated film cut by 1 cm width with a cutter knife.

TABLE 1

| | Polymer | | Peel |
|---|---|---|---|
| | contained in | | Strength |
| | Polymer Solution | Class of Amine | (kN/m) |
| Example 1 | polyallylamine | primary | 0.8 |
| Example 2 | polyvinylamine | primary | 0.7 |
| | polydiallylamine | secondary | 0.9 |
| | copolymer of | primary and | 0.9 |
| | polyallylamine and | secondary | |
| | polydiallylamine | | |
| | polyvinylamidine | primary | 0.8 |
| Comparative | polydiallylamine | tertiary | 0.2 |
| Example 1 | polydiallylamine | quaternary | 0.3 |
| | polyethyleneimine | primary, secondary | 0.3 |
| | | and tertiary | |
| | | on main chain | |
| | no polymer | quaternary | 0.2 |
| | (quaternary ammonium | | |
| | salt) | | |
| Comparative | no polymer | — | 0.1 |
| Example 2 | (not treated) | | |

The results showed that the polymer having a primary amine or a secondary amine on a side chain as in Example 1 enhanced adhesion, whereas the polymer having a tertiary amine or a quaternary amine on a side chain as in Comparative Example 1 exerted no effect in enhancing adhesion.

### Example 3

### Metallization of Insulating Resin

### (1) Hydrophilization Treatment

A polyimide film, Kapton 100EN (produced by Du Pont-Toray Co., Ltd.) was immersed in a sodium hydroxide aqueous solution (50 g/L) at 50° C. for 5 minutes to perform a hydrophilization treatment.

### (2) Conditioning Treatment

Following the hydrophilization treatment in the process (1) above, the resin was immersed in a polymer aqueous solution containing a polyallylamine (PAA-15C, produced by Nitto Boseki Co., Ltd.) in a concentration of 1 g/L at 50° C. for 5 minutes to perform a conditioning treatment.

### (3) Application of Catalyst

Following the conditioning treatment in the process (2) above, the resin was immersed in a palladium catalyst solution (PB-318, produced by Ebara-Udylite Co., Ltd.) at 40° C. for 5 minutes to perform application of the palladium catalyst, and then further subjected to an activation treatment with an activation solution (PB-445, produced by Ebara-Udylite Co., Ltd.) at 30° C. for 3 minutes.

### (4) Electroless Plating

Following the application of catalyst in the process (3) above, the resin was immersed in an electroless copper plating solution (PB-506, produced by Ebara-Udylite Co., Ltd.) at 30° C. for 15 minutes to form a copper plated film having a thickness of 0.5 μm on the resin. The resin was then dried in an oven at 120° C. for 1 hour.

### (5) Electroplating

Following the electroless plating in the process (4) above, the resin was immersed in a copper electroplating solution (CU-BRITE21, produced by Ebara-Udylite Co., Ltd.) and treated at an electric current density of 3 A/dm² for 40 minutes to form a copper plated film having a thickness of 25 μm on the resin. The resin was then dried in an oven at 180° C. for 1 hour to metallize the insulating resin.

90° peel strength of the plated product obtained by the above procedures was measured in the same manner as in Test Example 1. The 90° peel strength was 0.7 kN/m.

### Comparative Example 3

### Metallization of Insulating Resin

A plated product was obtained in the same manner as in Example 3 except that the polymer aqueous solution in the process (2) of Example 3 was replaced by an aqueous solution containing a cationic surfactant (Quartamin 24P, available from Kao Corporation) in a concentration of 1 g/L. The 90° peel strength of the plated product measured in the same manner as in Test Example 1 was 0.1 kN/m.

### INDUSTRIAL APPLICABILITY

An excellent plated product with enhanced adhesion between an insulating resin and a metal film can be conveniently obtained through metallization of an insulating resin by utilizing the method for conditioning an insulating resin of the present invention.

1. A method for conditioning an insulating resin containing a cyanate compound and an epoxy compound, the method comprising: hydrophilizing an insulating resin containing a cyanate compound and an epoxy compound, and then treating the insulating resin with a solution containing a polymer having a primary amine, a secondary amine or both of them on a side chain thereof.

2. (canceled)

3. (canceled)

4. The method for conditioning an insulating resin containing a cyanate compound and an epoxy compound according to claim 1, wherein the polymer having a primary amine, a secondary amine or both of them on a side chain thereof is a polymer of a monomer selected from a vinylamine, an allylamine, a diallylamine and a vinylamidine, or a copolymer of the monomers.

5. The method for conditioning an insulating resin containing a cyanate compound and an epoxy compound according to claim 1 or 4, wherein the insulating resin containing a cyanate compound and an epoxy compound has a surface roughness (Rz) of 1 μm or less.

6. A method for metallizing an insulating resin containing a cyanate compound and an epoxy compound, the method comprising: hydrophilizing an insulating resin containing a cyanate compound and an epoxy compound; treating the insulating resin with a solution containing a polymer having a primary amine, a secondary amine or both of them on a side chain thereof; applying a catalyst to the insulating resin; and subjecting the insulating resin to a metallization treatment.

7. (canceled)

8. (canceled)

9. The method for metallizing an insulating resin containing a cyanate compound and an epoxy compound according to claim 6, wherein the polymer having a primary amine, a secondary amine or both of them on a side chain thereof is a polymer of a monomer selected from a vinylamine, an allylamine, a diallylamine and a vinylamidine, or a copolymer of the monomers.

10. The method for metallizing an insulating resin containing a cyanate compound and an epoxy compound according to claim 6 or 9, wherein the insulating resin containing a cyanate compound and an epoxy compound has a surface roughness (Rz) of 1 lam or less.

11. The method for metallizing an insulating resin containing a cyanate compound and an epoxy compound according to any one of claims 6, 9 and 10, wherein the metallization treatment is electroless plating.

12. A conditioning liquid for an insulating resin containing a cyanate compound and an epoxy compound, comprising a polymer having a primary amine, a secondary amine or both of them on a side chain thereof.

13. The conditioning liquid for an insulating resin containing a cyanate compound and an epoxy compound according to claim 12, wherein the polymer having a primary amine, a secondary amine or both of them on a side chain thereof is a polymer of a monomer selected from a vinylamine, an allylamine, a diallylamine and a vinylamidine, or a copolymer of the monomers.

14. A metal-plated product obtained by the method for metallizing an insulating resin containing a cyanate compound and an epoxy compound according to any one of claims 6 and 9 to 11.

15. The metal-plated product according to claim 14, which has a 90° peel strength according to JIS C5012 of 0.5 kN/m or more.
